(19) United States
(12) Patent Application Publication
(10) Pub. No.: US 2026/0203246 A1
(43) Pub. Date: Jul. 16, 2026

(54) Method and Apparatus for Controlling Communication Based On a Hardware Partition System, and Server

(71) Applicant: SUZHOU METABRAIN INTELLIGENT TECHNOLOGY CO., LTD., Suzhou, Jiangsu (CN)

(72) Inventors: Chaofan CHEN, Suzhou, Jiangsu (CN); Baoyang LIU, Suzhou, Jiangsu (CN); Jin CHEN, Suzhou, Jiangsu (CN)

(73) Assignee: SUZHOU METABRAIN INTELLIGENT TECHNOLOGY CO., LTD., Suzhou, Jiangsu (CN)

(21) Appl. No.: 19/137,521

(22) PCT Filed: May 23, 2024
(86) PCT No.: PCT/CN2024/095002

§ 371 Date: Jun. 10, 2025

(30) Foreign Application Priority Data
Oct. 10, 2023 (CN) 202311307559.4

(51) Int. Cl. G06F 15/173

(52) U.S. Cl. CPC G06F 15/173

(57) ABSTRACT

A method and an apparatus for controlling communication based on a hardware partition system, and server. The method includes: acquiring command data to be sent by a second operating system through a first operating system; recombining the command data to be sent through the first operating system, obtain a target command message corresponding to the command data to be sent, where a target address in the target command message is a communication address of a target hardware partition system corresponding to the second operating system; and sending the target command message onto a target communication bus through the target communication interface of the first operating system such that the target hardware partition system receives the target command message on the target communication bus through a target hardware partition system.

### CROSS-REFERENCE TO RELATED APPLICATION

This disclosure claims priority to Chinese Patent Application No. 202311307559.4 filed to the China National Intellectual Property Administration on Oct. 10, 2023 and entitled “Method and Apparatus for Controlling Communication Based On a Hardware Partition System, and Server”, the disclosure of which is hereby incorporated by reference in its entirety.

### TECHNICAL FIELD

Embodiments of the present disclosure relate to the field of computers, and in particular, to a method and apparatus for controlling communication based on a hardware partition system, and a server.

### BACKGROUND

In the field of the server industry, the sharing of hardware computing resources and the increasing of a utilization rate of a multi-core processor can use a technology of hardware partition of computing resources for a host system. One server is partitioned into two or even more physical host systems, which individually bear services and provide the services. In order to ensure the long-term stable and efficient operation of a server, a server system needs to have the capability of effectively monitoring each partition system.

In the related art, a management unit (i.e., a server management unit) used by the server is generally a Baseboard Management Controller (BMC). The server management unit can acquire operating state and fault state information of the server through a link interface corresponding to the server management unit, so as to provide guarantees for the health status monitoring and fault analysis and positioning of the server system.

However, in a scenario of a server hardware partition system, each partition system operates in parallel, and by using the above method for monitoring a state of the server, the effective monitoring of each partition system cannot be ensured. Therefore, methods for monitoring the state of the server system through the server management unit have the problem of poor monitoring effectiveness for a plurality of partition systems.

### SUMMARY

Embodiments of the present disclosure provide a method and apparatus for controlling communication based on a hardware partition system, and a server, so as to at least solve the problem of poor monitoring effectiveness for a plurality of partition systems in the methods for monitoring a state of a server system through a server management unit in the related art.

An aspect of the embodiments of the present disclosure provides a method for controlling communication based on a hardware partition system, which is applied to a server comprising a Baseboard Management Controller (BMC) and a host system, wherein the BMC communicates with the host system through a target communication bus, at least two operating systems are operated on a multi-core processor of the BMC, the host system is divided into a plurality of hardware partition systems, one of the at least two operating systems is configured to monitor an operating state of at least one of the plurality of hardware partition systems, a target communication interface of the BMC is configured for a first operating system in the at least two operating systems, and the target communication interface is a communication interface corresponding to the target communication bus. The method includes: acquiring command data to be sent by a second operating system through the first operating system, wherein the second operating system is any one of the at least two operating systems other than the first operating system; recombining the command data to be sent through the first operating system, to obtain a target command message corresponding to the command data to be sent, wherein a target address in the target command message is a communication address of a target hardware partition system corresponding to the second operating system within the plurality of hardware partition systems; and sending the target command message onto the target communication bus through the target communication interface of the first operating system such that the target hardware partition system receives the target command message on the target communication bus through a target communication interface of the target hardware partition system.

Another aspect of the embodiments of the present disclosure provides an apparatus for controlling communication based on a hardware partition system, which is applied to a server comprising a Baseboard Management Controller (BMC) and a host system, wherein the BMC communicates with the host system through a target communication bus, at least two operating systems are operated on a multi-core processor of the BMC, the host system is divided into a plurality of hardware partition systems, one of the at least two operating systems is configured to monitor an operating state of at least one of the plurality of hardware partition systems, a target communication interface of the BMC is configured for a first operating system in the at least two operating systems, and the target communication interface is a communication interface corresponding to the target communication bus. The apparatus includes: an acquisition unit, configured to acquire command data to be sent by a second operating system through the first operating system, wherein the second operating system is any one of the at least two operating systems other than the first operating system; a recombination unit, configured to recombine the command data to be sent through the first operating system, to obtain a target command message corresponding to the command data to be sent, wherein a target address in the target command message is a communication address of a target hardware partition system corresponding to the second operating system within the plurality of hardware partition systems; and a sending unit, configured to send the target command message onto the target communication bus through the target communication interface of the first operating system such that the target hardware partition system receives the target command message on the target communication bus through a target communication interface of the target hardware partition system.

Still another aspect of the embodiments of the present disclosure provides a host system, a Baseboard Management Controller (BMC), and a target communication bus between the host system and the BMC, wherein at least two operating systems are operated on a multi-core processor of the BMC, the host system is divided into a plurality of hardware partition systems, one of the at least two operating systems is configured to monitor an operating state of at least one of the plurality of hardware partition systems, a target communication interface of the BMC is configured for a first operating system in the at least two operating systems, and the target communication interface is a communication interface corresponding to the target communication bus. The first operating system is configured to: acquire command data to be sent by a second operating system, wherein the second operating system is any one of the at least two operating systems other than the first operating system; recombine the command data to be sent, to obtain a target command message corresponding to the command data to be sent, wherein a target address in the target command message is a communication address of a target hardware partition system corresponding to the second operating system within the plurality of hardware partition systems; and send the target command message onto the target communication bus through the target communication interface of the first operating system; and the target hardware partition system is configured to receive the target command message on the target communication bus through a target communication interface of the target hardware partition system.

Still another aspect of the embodiments of the present disclosure provides a BMC. At least two operating systems are operated on a multi-core processor of the BMC, one of the at least two operating systems is configured to monitor an operating state of at least one of a plurality of hardware partition systems into which a host system is divided, the BMC communicates with the host system through a target communication bus, a target communication interface of the BMC is configured for a first operating system in the at least two operating systems, the target communication interface is a communication interface corresponding to the target communication bus, and the at least two operating systems further comprise a second operating system. The first operating system is configured to: acquire command data to be sent by the second operating system, wherein the second operating system is any one of the at least two operating systems other than the first operating system; recombine the command data to be sent, to obtain a target command message corresponding to the command data to be sent, wherein a target address in the target command message is a communication address of a target hardware partition system corresponding to the second operating system within the plurality of hardware partition systems; and send the target command message onto the target communication bus through the target communication interface of the first operating system such that the target hardware partition system receives the target command message on the target communication bus through a target communication interface of the target hardware partition system.

Still another aspect of the embodiments of the present disclosure further provides a non-volatile readable storage medium. The non-volatile readable storage medium stores a computer program. Steps in any one of the above method embodiments are executed when the computer program is configured to run.

Still another aspect of the embodiments of the present disclosure further provides an electronic device. The electronic device includes a memory and a processor. The memory is configured to store a computer program. The processor is configured to run the computer program to execute steps in any one of method embodiments described above.

Through the embodiments of the present disclosure, by means of operating at least two operating systems on the multi-core processor of the BMC, and configuring the communication interface of the BMC to one of the operating systems, the BMC communicates with the host system through the target communication bus, at least two operating systems are operated on the multi-core processor of the BMC, one operating system is configured to monitor the operating state of at least one hardware partition system divided by the host system, the target communication interface of the BMC is configured to the first operating system in the at least two operating systems, and the target communication interface is the communication interface corresponding to the target communication bus. The first operating system acquires the command data to be sent by the second operating system, and the second operating system is any operating system other than the first operating system. The command data to be sent is recombined to obtain the target command message, and the target address in the target command message is the communication address of the target hardware partition system corresponding to the second operating system. The target command message is sent onto the target communication bus through the target communication interface of the first operating system such that the target hardware partition system receives the target command message on the target communication bus through the target communication interface of the target hardware partition system. Since the communication with each hardware partition system in the host system, as well as the communication inside the BMC with other operating systems, are realized by the specified operating system, through the above design, the effective monitoring of each partition system in a host system hardware partition scenario can be realized, so as to achieve the effect of independent management of each partition system, such that the problem of poor monitoring effectiveness for a plurality of partition systems in the methods for monitoring a state of a server system through a server management unit in the related art can be solved.

### BRIEF DESCRIPTION OF THE DRAWINGS

FIG. 1 is a block diagram of a hardware structure of an optional computer terminal according to embodiments of the present disclosure.

FIG. 2 is a schematic flowchart of an optional method for controlling communication based on a hardware partition system according to embodiments of the present disclosure.

FIG. 3 is a schematic diagram of an optional system architecture according to embodiments of the present disclosure.

FIG. 4 is a schematic diagram of an optional PECI command according to embodiments of the present disclosure.

FIG. 5 is a schematic diagram of an optional Ping command according to embodiments of the present disclosure.

FIG. 6 is a schematic diagram of memory distribution of an optional data structure according to embodiments of the present disclosure.

FIG. 7 is a schematic flowchart of another optional method for controlling communication based on a hardware partition system according to embodiments of the present disclosure.

FIG. 8 is a schematic diagram of memory distribution of another data structure according to embodiments of the present disclosure.

FIG. 9 is a schematic flowchart of still another optional method for controlling communication based on a hardware partition system according to embodiments of the present disclosure.

FIG. 10 is a block structural diagram of an apparatus for controlling communication based on a hardware partition system according to embodiments of the present disclosure.

### DETAILED DESCRIPTION OF THE EMBODIMENTS

The embodiments of the present disclosure are described below in detail with reference to the drawings and the embodiments. It is to be noted that terms “first”, “second” and the like in the description, claims and the above mentioned drawings in the embodiments of the present disclosure are used for distinguishing similar objects rather than describing a specified sequence or a precedence order.

As semiconductor industries and integrated circuit technologies rapidly develop, a processor has become an important computing unit in the fields such as cloud computing, artificial intelligence, big data, etc. In order to achieve the sharing of hardware computing resources and increasing the utilization rate of a multi-core processor, a virtualization technology can be introduced, that is, a plurality of virtual machines are virtualized based on a processor hardware platform, and each virtual machine runs an independent operating system. However, the virtual machine-based operating systems are generally unable to meet real-time requirements of the services due to increased overhead such as virtual machine management. Therefore, the operating systems are run generally by directly using the form of monopolizing a physical machine, and such “bare metal”-type processor use method can significantly reduce service processing delays.

In the field of server industry, a technology of hardware partition of computing resources for a Central Processing Unit (CPU, which is used as a computing and control core of a computer system, and a final execution unit for information processing and program running) of a host system can be used. One server is partitioned into two or even more physical host systems (i.e., hardware partition systems), which individually bear services and provide the services. In order to ensure the long-term stable and efficient operation of a server, a server system needs to have the capability of effectively monitoring each partition system, which proposes a new monitoring requirement for the system design of a server management unit, so as to ensure that the operating of each partition system can be effectively monitored.

The server management unit can be a BMC, or can also be other management units. By using the BMC as an example, the BMC can acquire the temperature and power consumption of the CPU of the server, and fault state information of a key unit module, so as to provide powerful guarantees for the health state monitoring, fault analysis and positioning of the server system. The key unit module can include, but is not limited to, at least one of the following: the CPU, an Ultra Path Interconnect (UPI) link, a memory controller, a Platform Environment Control Interface (PECI, which is configured to perform information interaction between a server BMC and an Intel architecture CPU) link, etc.

However, since the server is generally configured with one BMC management unit, that is, there is only one communication interface, in a scenario of a server hardware partition system, there can be a problem that each hardware partition system cannot independently use the communication interface, thus affecting the independence of fault management functions of different partition systems of the same server platform. In order to handling the above problem, a solution that can be used is: a CUP architecture of a BMC is upgraded, that is, a communication interface module (e.g., a PECI interface module) facing a plurality of hardware partition systems of a host is re-designed. However, the above solution brings two challenges: the first challenge is that the upgrading of the BMC CPU architecture needs to do a hardware partition design inside the BMC, such that design complexity is significantly increased, thus inevitably leading to a great increase in chip costs; and the second challenge is that steps such as chip design, tape-out, manufacturing, debugging, etc. for the upgrading of the BMC CPU architecture occupy a large number of time cycles, leading to a serious impact on the application and promotion of the host system hardware partition technology, thus not facilitating the rapid promotion and application of a new technology.

In order to at least solve the above problem, by operating at least two operating systems on the multi-core processor of the BMC, the hardware partition systems of the host system are respectively monitored. In the at least two operating systems, one of the specified operating system is configured to a communication interface of the BMC, such that the communication with each hardware partition system in the host system, as well as the communication inside the BMC with other operating systems, are realized by the specified operating system. Through the above design, the effective monitoring of each partition system in the host system hardware partition scenario can be realized, so as to achieve the effect of independent management of each partition system.

The method embodiments provided in the embodiments of the present disclosure can be executed in a mobile terminal, a computer terminal or a similar computing apparatus. For example, the method embodiments are operated on the computer terminal, FIG. 1 is a block diagram of a hardware structure of an optional computer terminal according to embodiments of the present disclosure. As shown in FIG. 1, the computer terminal can include one or more (only one is shown in FIG. 1) processors 102 (the processor 102 can include, but is not limited to, a processing apparatus such as a microprocessor MCU or a programmable logic device FPGA) and a memory 104 for storing data. The above computer terminal can further include a transmission device 106 for achieving a communication function and an input/output device 108. Those skilled in the art can understand that the structure shown in FIG. 1 is only a schematic diagram, which does not limit the structure of the above computer terminal. For example, the computer terminal can further include more or less components than those shown in FIG. 1, or have a different configuration from that shown in FIG. 1.

The memory 104 can be configured to store a computer program, for example, a software program and a module of application software, such as a computer program corresponding to a method for controlling communication based on a hardware partition system in the embodiments of the present disclosure. The processor 102 runs the computer program stored in the memory 104, so as to execute various functional applications and data processing, that is, to realize the above method. The memory 104 can include a high-speed random access memory, and can further include a non-volatile memory, such as one or more magnetic disk memory apparatuses, a flash memory device, or other non-volatile solid-state memory devices. In some embodiments, the memory 104 can further include memories remotely disposed relative to the processor 102. The remote memories can be connected to the mobile terminal by using a network. Examples of the above network include, but are not limited to, the Internet, an intranet, a local area network, a mobile communication network, and a combination thereof.

The transmission device 106 is configured to receive or transmit data via a network. The optional example of the above network can include a wireless network provided by a communication provider of the computer terminal. In an example, the transmission device 106 includes a Network Interface Controller (NIC), and can be connected to other network devices by using a base station, so as to communicate with the Internet. In an example, the transmission device 106 can be a Radio Frequency (RF) module, which is configured to communicate with the Internet in a wireless manner.

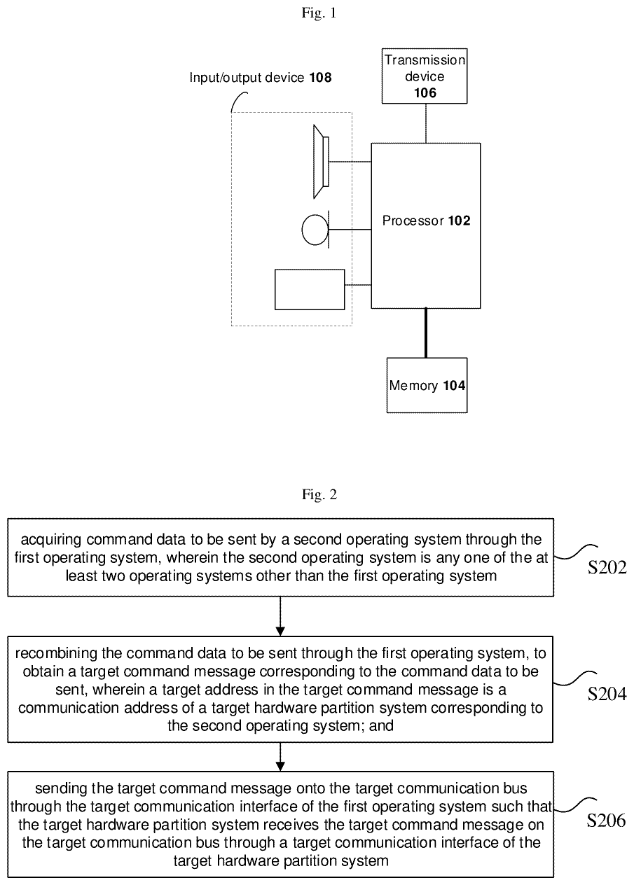

An aspect of the embodiments of the present disclosure provides a method for controlling communication based on a hardware partition system. For example, the method for controlling communication based on a hardware partition system in this embodiment is executed by a server. FIG. 2 is a schematic flowchart of an optional method for controlling communication based on a hardware partition system according to embodiments of the present disclosure. As shown in FIG. 2, the flow includes the following steps.

At S202, acquiring command data to be sent by a second operating system through the first operating system, wherein the second operating system is any one of the at least two operating systems other than the first operating system.

The method for controlling communication based on a hardware partition system in this embodiment can be applied to a host system hardware partition scenario. Through a scenario in which a BMC performs communication control on a plurality of hardware partition systems, the effective monitoring (e.g., fault monitoring) of each partition system in the host system hardware partition scenario can be realized. The server includes a host system and a corresponding BMC. The host system performs hardware partition to obtain the plurality of hardware partition systems (or referred to as partition systems). The BMC has a multi-core processor, and at least two operating systems are operated on the multi-core processor. One of the at least two operating systems is configured to monitor an operating state of at least one of the plurality of hardware partition systems. Here, a correspondence relationship between the operating system and the hardware partition system can be a one-to-one relationship, or can also be a one-to-many relationship. The BMC communicates with the host system through a target communication bus, and a target communication interface of the BMC is configured to the first operating system, such that the target communication interface can be used to interact with the host system side through the first operating system, and to interact with other operating systems in the at least two operating systems, so as to realize independent management of the BMC to each hardware partition system.

Optionally, a hardware partition of the host system can be implemented based on a CPU or other processing units. A hardware resource of the host system is divided into a plurality of hardware partitions, and each hardware partition corresponds to at least one CPU processor, which is equivalent to that the host system is divided into a plurality of hardware partition systems, and each hardware partition includes computing, storage, a network, Input/Output (IO), etc. required for the operation of the system itself. Each operating system can operate independently, can be a Linux system (known as GNU/Linux, a freely distributable Unix-like operating system), or can also be other operating systems and combinations. Here, the Linux system is a Portable Operating System Interface (POSIX)-based multi-user multi-task operating system supporting a plurality of threads and a plurality of CPUs.

In an exemplary embodiment, a link used to achieve the communication between the BMC and the host system can be a PECI link. Under the PECI link, the target communication bus is a PCIe bus, the target communication interface is a PECI, and the PECI is controlled by a corresponding interface controller (i.e., a PECI controller). A communication interface of the BMC side can match a communication interface of the corresponding hardware partition system, for example, communication addresses used are the same, or other communication control modes can also be used.

Here, according to a PECI related protocol, the PECI can be divided into a Host device and a Client device, each communication is initiated by the Host device, and the Host device acquires corresponding information through different PECI commands. In the server system, the BMC is the Host device, and each CPU processor of a Host side is the Client device. Correspondingly, the communication between each operating system and the hardware partition system corresponding to each operating system is initiated by each operating system as the Host device to the hardware partition system corresponding to each operating system as the Client device. The PECI of the BMC is distributed to the first operating system through a PECI controller that only allows the first operating system to access the BMC.

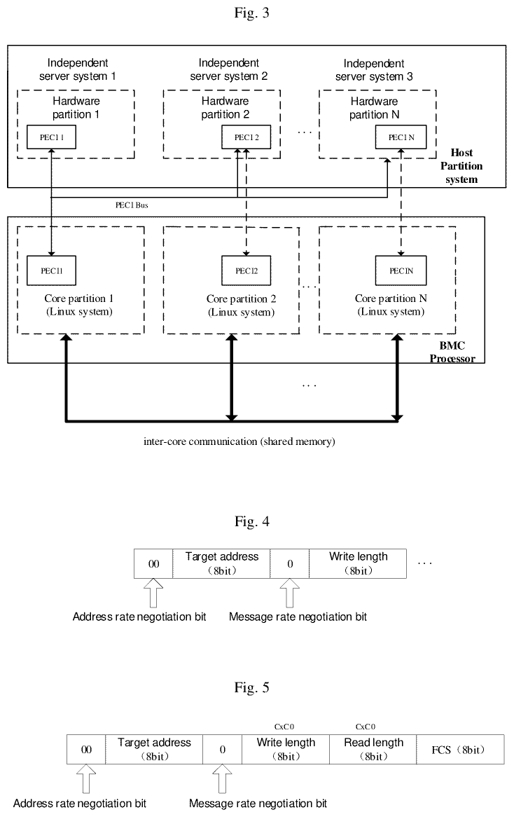

For example, a virtual extension solution of the PECI link under the hardware partition system can be used. The Host side is divided into N hardware partitions according to the number of CPUs, and each partition corresponds to one CPU processor, which is equivalent to that the entire host system is divided into N independent server systems, where N is a positive integer greater than 1. In order to realize independent monitoring and management of each independent server system, the multi-core processor of the BMC is divided into N core partitions by using a core as a unit, respectively corresponding to Core 1, Core 2, . . . , Core N. Each core partition operates one Linux system. In this case, a plurality of Linux systems are operated in the BMC having a multi-core processor hard core: Linux system 1, Linux system 2, . . . , Linux system N. These N Linux systems operate independently, and are respectively responsible for the monitoring and managing of the N hardware partitions of the Host side, as shown in FIG. 3.

Here, each independent server system of the Host side has one PECI (the PECI controlled by the PECI controller). Since there is only one PECI controller in the BMC, in order to achieve a PECI communication function between the BMC and each hardware partition of the Host, the BMC distributes an access permission of the PECI controller to the Linux system 1, that is, only the Linux system 1 can access the PECI controller. Through the above arrangement mode, the N partitions of the BMC processor only have one physical PECI (located in the Core partition 1), and the PECI of the BMC side is connected to the PECI in each hardware partition system of the Host side through a PECI bus; and a PECI of the Core partition 1 is connected to the PECI of each partition system of the Host side through the bus, and the rest of the Core partitions perform data interaction with the Core partition 1 through a shared memory or other manners. Furthermore, each partition of the BMC side operates the Linux operating system, and is responsible for the monitoring and managing of each independent server system of the Host side. The sharing and transmitting of each partition data of the BMC side are implemented through inter-core communication.

In order to realize the virtual extension of the PECI link under the hardware partition system, a communication principle under the system architecture is that the PECI controller of the Linux system 1 first communicates with the hardware partition system of the Host side first, so as to acquire information such as a CPU temperature, power consumption, a fault register, etc. of each partition system of the Host side; and then, the Linux system 1 distributes these acquired information to the corresponding Linux system of the BMC side by means of inter-core communication according to a PECI address corresponding to the CPU of each hardware partition system of the Host side. In this way, from the level of a system architecture, a PECI communication link is constructed between each hardware partition system of the Host side and the Linux system of the BMC side. Since these links do not physically exist, the virtual extension of the PECI link under the hardware partition system is completed actually, thereby realizing the independent management of the BMC to each Host hardware partition system.

Here, under the system architecture, a PECI link-based access mechanism between different Core partitions of a BMC management unit and the hardware partition systems of the Host side is designed, a virtual PECI link between the BMC and the Host under the hardware partition system is constructed, such that the virtual extension of the PECI link is realized, each partition under the hardware partition system can independently share the function of the PECI link without considering the upgrading of the BMC architecture, and an increase in chip cost caused by the upgrading of the BMC processor architecture is avoided, thereby reducing the design cost of the server system, and finally achieving the objective of significantly reducing the cost of the entire hardware partition system and improving the computing performance of the host system and BMC system.

When command data is sent, the first operating system can acquire command data to be sent by the second operating system, that is, command data to be sent to the corresponding hardware partition system by the second operating system. The command data here can be an encapsulated command message, or can also be data required to generate a command message (the generation of the command message is executed by the first operating system). The manner of acquiring the command data to be sent can be any manner of performing data transmission among different operating systems operated on any same BMC.

The second operating system can be any operating system in the at least two operating systems.

At S204, recombining the command data to be sent through the first operating system, to obtain a target command message corresponding to the command data to be sent, wherein a target address in the target command message is a communication address of a target hardware partition system corresponding to the second operating system within the plurality of hardware partition systems.

After the command data to be sent by the second operating system is acquired, the first operating system can recombine the command data to be sent, so as to obtain a command message corresponding to the command data to be sent, that is, the target command message. The target command message can include a target address and other information, and the target address can be a communication address of a target hardware partition system corresponding to the second operating system, for example, a PECI address. The target command message can be any PECI command, and can include, but is not limited to, a Ping command, GetDIB, GetTemp, RdIAMSR, WrIAMSR, etc. Command formats corresponding to different commands are slightly different, but the command formats of different commands all include fields such as the target addresses, write lengths, etc.

For example, a transmission format of the PECI command can be shown in FIG. 4, the first is an address rate negotiation bit, which can be two-bit 0, and is configured to determine a transmission rate before transmitting address information between the Host device and the Client device of the PECI bus; the second is a target address field, with a bit wide being 8 bits, and is configured to assign a PECI address of the Client device; the next is a message rate negotiation bit, which can be 1 bit 0, and is configured to determine a transmission rate before transmitting message information between the Host device and the Client device of the PECI bus; and the next is a write length field, with a bit wide being 8 bits, and is configured to identify an effective byte count subsequently written.

By using the Ping command as an example, the Ping command is a command that is used for the Host device on the PECI bus to confirm whether the Client device exists, and the command message transmission format is shown in FIG. 5.

At S206, sending the target command message onto the target communication bus through the target communication interface of the first operating system such that the target hardware partition system receives the target command message on the target communication bus through a target communication interface of the target hardware partition system.

Since in addition to that the first operating system has an accessible PECI physical interface, other operating systems do not have the accessible PECI physical interfaces, after the target command message corresponding to the command data to be sent is obtained, the first operating system can send the target command message onto the target communication bus through the target communication interface of the first operating system such that the target hardware partition system receives the target command message on the target communication bus through a target communication interface of the target hardware partition system. The target communication interface can be a PECI or other interfaces. The target communication bus can be a PECI bus or other buses.

For example, by using the Ping command as an example, that the BMC side sends the Ping command to the Host side have two situations. The first situation is that the Core partition 1 sends the Ping command that the target address is the CPU 1 of the Host side; and the second situation is that the Core 2-Core N partitions send the Ping commands that the target addresses are the CPU 2-CPU N of the Host side.

For the first situation, the Linux system of the Core partition 1 of the BMC sends the data onto the PECI bus shown in FIG. 3 through the PECI of the partition according to a message transmission format shown in FIG. 5, and the target address therein is filled with a PECI address of the CPU 1. Here, a PECI protocol generally supports 8 PECI addresses, which respectively are 0x30-0x37. In order to adapt to the PECI addresses, the number of partitions of the Host side does not exceed 8, 0x30 corresponds to the hardware partition 1 of the Host side, 0x31 corresponds to the hardware partition 2 of the Host side, and so on; and a write length and a read length both are 0x00.

For the second situation, for example, the Core partition 2 sends the Ping command to the CPU 2. Since the Core partition 2 does not have an accessible PECI physical interface, the partition cannot directly send the corresponding Ping command to the CPU 2 of the Host side. For this purpose, the function is completed by using the form of information forwarding, that is, the Linux system of the Core partition 2 first sends corresponding information such as the target address, a command code (i.e., the Ping command), the write length, the read length, etc. to the Linux system of the Core partition 1, the Core partition 1 analyze and then recombine the data to be sent, so as to be converted to accord with a Ping command message shown in FIG. 5 to send to the PECI bus.

Here, the BMC processor is divided into different Core partitions according to cores, and only the Core partition 1 has an access permission of the PECI controller. Each Core partition separately operates the independent Linux system, and is logically responsible for the independent monitoring and management of the Host hardware partition system. When other Core partitions (partitions other than the Core partition 1) need to access the corresponding hardware partition system of the Host side through the PECI, due to the non-existence of an actual physical link, the objective of PECI communication cannot be directly achieved.

The purpose of indirectly accessing the corresponding hardware partition system of the Host side through the PECI controller of the Core 1 is realized by means of a shared memory between the Cores and the Core 1. In this way, from the level of the system architecture, extension of a PECI virtual link from the Core partitions of the BMC side to the hardware partition systems of the Host side is realized.

The number of PECI communication channels of a BMC architecture under the hardware partition system can be significantly extended, such that the hardware partition system has good adaptability, and the problem of handling cost increasing caused by BMC architecture upgrading of the hardware partition system is avoided, thereby effectively improving the computing performance of the host system and BMC management unit, and facilitating promotion of development and promotion application of a host system hardware partition technology.

Through the above steps, the command data to be sent by the second operating system is acquired through the first operating system, where the second operating system is any operating system in the at least two operating systems other than the first operating system; the command data to be sent is recombined through the first operating system, so as to obtain the target command message corresponding to the command data to be sent, where the target address in the target command message is the communication address of the target hardware partition system corresponding to the second operating system; and the target command message is sent onto the target communication bus through the target communication interface of the first operating system such that the target hardware partition system receives the target command message on the target communication bus through the target communication interface of the target hardware partition system. Therefore, the problem of poor monitoring effectiveness for a plurality of partition systems in the methods for monitoring a state of a server system through a server management unit in the related art can be solved, thereby improving the effectiveness of the monitoring of the plurality of partition systems.

In an exemplary embodiment, acquiring the command data to be sent by the second operating system through the first operating system includes the following step.

At S11, when it is determined that there is the command data to be sent by the second operating system, acquiring the command data to be sent from a first shared memory through the first operating system, wherein the first shared memory is configured to store command data to be sent by the other operating systems in the at least two operating systems other than the first operating system.

In this embodiment, the command data to be sent can be sent to the first operating system through the first shared memory. The first shared memory is a shared memory of the at least two operating systems, and can be configured to store command data to be sent by other operating systems in the at least two operating systems other than the first operating system. Each of the at least two operating systems is allowed to access the shared memory. Operation permissions of different operating systems to the first shared memory can be the same, or can also be different. For example, the first operating system can have a read permission of the first shared memory, and other operating systems have read-write permissions of the first shared memory.

If there is command data to be sent (i.e., the command data to be sent) by the second operating system, the second operating system can write the command data to be sent to the first shared memory. If it is determined that there is command data to be sent by the second operating system, the first operating system can acquire the command data to be sent by the second operating system from the first shared memory, so as to obtain the command data to be sent.

For example, the Linux system of the Core partition 2 puts the corresponding information such as the target address, the command code (i.e., the Ping command), the write length, the read length, etc. into the shared memory. When the Linux system of the Core partition 1 determines that there is command data to be sent by the Linux system of the Core partition 2, the data putted by the Linux system of the Core partition 2 can be acquired from the shared memory.

Through this embodiment, data transmission is performed among different operating systems of the same BMC through the shared memory, such that the flexibility of data transmission can be improved, and requirements for the real-time performance of data transmission are reduced at the same time.

In an exemplary embodiment, wherein when it is determined that there is the command data to be sent by the second operating system, acquiring the command data to be sent from the first shared memory through the first operating system includes the following step.

At S21, when it is determined that there is the command data to be sent by the second operating system, acquiring the command data to be sent from a first data structure of the first shared memory according to a system identifier of the second operating system through the first operating system, wherein the first data structure is configured to store command data to be sent by the other operating systems by using at least one command parameter according to system identifiers of the other operating systems, and the command data to be sent by the other operating systems comprises parameter information of the at least one command parameter corresponding to the other operating systems.

In this embodiment, the command data to be sent by other operating systems can be stored by the first data structure of the first shared memory. Through the special designing of the data structure, it can indicate which operating systems (e.g., Core partition) different pieces of command data belong to, for example, the command data to be sent by the Core partition 2 is indicated through the special designing of the data structure in the shared memory. The first data structure can be configured to store the command data to be sent by other operating systems by using at least one command parameter according to system identifiers of other operating systems, and the command data to be sent by other operating systems includes parameter information of the at least one command parameter corresponding to other operating systems.

Here, the at least one command parameter can be one or more parameters that are preset and can be adapted to different types of command messages. In order to avoid waste of storage space caused by excessive set parameters, the at least one command parameter can include a common parameter in various command messages and a parameter that adapts to other non-common parameters. Exemplarily, the at least one command parameter includes one of the following: a write length, a read length, a command code, or a write parameter; in the first data structure, the parameter information of the at least one command parameter corresponding to the same other operating system is sequentially continuously stored; or in the first data structure, the parameter information of the same command parameter in the at least one command parameter corresponding to the plurality of other operating systems is sequentially continuously stored. Furthermore, the first data structure can or can not store the system identifier, and only includes parameter information of at least one command parameter, as long as a correspondence relationship between each operating system and a storage position (e.g., a start position, a space size, etc.) of the command data to be sent by each operating system is configured.

For example, definitions of the data structures of the data sent by the Core 2-Core 8 of the BMC side can be shown in Table 1.

TABLE 1

| Serial | Variable | Variable | |
|---|---|---|---|
| number | name | type | Description |
| 1 | CoreNum | unsigned | Indicate Core partition number to which |
| | (optional) | char | the data is sent |
| 2 | WtLen | unsigned | Write length of PECI command |
| | | char | |
| 3 | RdLen | unsigned | Read length of PECI command |
| | | char | |
| 4 | Cmd | unsigned | Command code of PECI command |
| | | char | |
| 5 | Para | unsigned | Write parameter of PECI command |
| | | char[30] | |

The write parameter of the PECI command can be allowed to write one or more parameters, that is, other parameters other than the write length, the read length, and the command code.

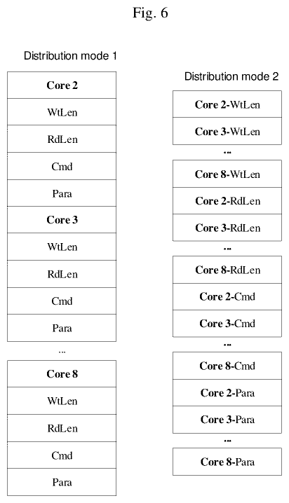

A distribution mode of the data structure in the memory can be shown in FIG. 6. FIG. 6 shows two possible distribution modes. In addition to the distribution mode shown in FIG. 6, there can also be other distribution modes, which are not enumerated one by one herein.

If there is command data to be sent by the second operating system, the first operating system can acquire the command data to be sent from the first data structure of the first shared memory according to the system identifier of the second operating system. The acquisition mode can include: based on the system identifier of the second operating system, parameter information of the at least one command parameter corresponding to the second operating system is read from the first data structure, so as to obtain the command data to be sent.

Through this embodiment, which operating system the command data belongs to is indicated through the special designing of the data structure, such that the accuracy of data transmission can be improved.

In an exemplary embodiment, there are a plurality of other operating systems, that is, in addition to including the first operating system, the at least two operating systems further include the plurality of other operating systems (operating systems that are not distributed with communication interfaces). System identifiers of the at least two operating systems are continuously arranged. For a scenario in which each operating system operates on one core partition, a serial number of the core partition can be used as a system identifier of the operating system operated. In the first data structure, the command data to be sent (the command data to be sent by some operating systems can be null) by the plurality of other operating systems is stored according to a sequence of the system identifiers of the plurality of other operating systems, for example, a distribution mode 1 is shown in FIG. 6.

Correspondingly, when it is determined that there is the command data to be sent by the second operating system, acquiring the command data to be sent from the first data structure of the first shared memory according to the system identifier of the second operating system through the first operating system includes the following step.

At S31, when it is determined that there is the command data to be sent by the second operating system, acquiring the command data to be sent from a storage position corresponding to the system identifier of the second operating system in the first data structure through the first operating system.

For the situation that the command data to be sent by each of other operating systems is stored according to the sequence of the system identifiers of the plurality of other operating systems, the storage position of the command data to be sent by each of other operating systems is fixed. In this case, the storage position of the command data to be sent by the second operating system can be determined by traversing the first data structure (e.g., after the system identifier of the second operating system is found, the command data to be sent by the second operating system is determined based on a relationship between the at least one command parameter and the storage position of the system identifier), or the command data to be sent can also be directly acquired from the storage position corresponding to the system identifier of the second operating system in the first data structure.

Through this embodiment, the efficiency of data acquisition can be improved by directly acquiring the stored command data based on the correspondence relationship between the system identifier and the storage position of the corresponding command data.

In an exemplary embodiment, acquiring the command data to be sent by the second operating system through the first operating system includes the following step.

At S41, receiving a first inter-core communication request sent by the second operating system through the first operating system, wherein the first inter-core communication request carries the command data to be sent.

In this embodiment, the command data to be sent can also be transmitted by using an existing inter-core communication request or a newly-defined inter-core communication request. Here, the newly-defined inter-core communication request can be an inter-core communication request based on an existing inter-core communication protocol, or can also be an inter-core communication request based on a new inter-core communication protocol, which is not limited thereto in this embodiment, as long as the command data to be sent can be transmitted through the inter-core communication request.

For the command data to be sent by the second operating system, the second operating system can send the first inter-core communication request to the first operating system, and the inter-core communication request carries the command data to be sent by the second operating system, that is, the command data to be sent.

Through this embodiment, the timeliness of response data transmission can be improved by using the inter-core communication request to transmit the response data.

In an exemplary embodiment, similar to the foregoing embodiments, there can be a plurality of other operating systems in the at last two operating systems. In this case, a second data structure can be pre-defined. A ready-to-send flag bit (a sending Ready flag bit, or also referred to as a data ready-to-send flag bit) corresponding to each of other operating systems can be set in the data structure, so as to identify whether there is command data to be sent by the corresponding operating system. When the ready-to-send flag bit is a first value (e.g., 1 or 0), it indicates that there is command data to be sent by the corresponding operating system; when a ready-to-receive flag bit is a second value (e.g., 0 or 1), it indicates that there is no command data to be sent by the corresponding operating system; and whether there is command data to be sent by other operating systems is determined by the first operating system based on the ready-to-send flag bit corresponding to each of other operating systems, so as to learn whether there is command data to be sent by other operating systems.

For example, definitions of the data structures of the sending Ready flag bit of the Core 2-Core 8 of the BMC side can be shown in Table 2.

TABLE 2

| Serial | | Variable | |
|---|---|---|---|
| number | Variable name | type | Description |
| 1 | Tx_Rdy_Flg | unsigned | A bit wide is 8 bits, the top digit is invalid, the lower 7 bits |
| | | char | respectively correspond to the Core 2-Core 8 partitions, when |
| | | | each bit is 1, it indicates that data sent by the corresponding Core |
| | | | in the shared memory is valid, and when each bit is 0, it indicates |
| | | | that the data sent by the corresponding Core in the shared memory |
| | | | is invalid. |

Correspondingly, before acquiring the command data to be sent by the second operating system through the first operating system, the method further includes the following steps.

At S51, sequentially detecting a ready-to-send flag bit corresponding to each other operating system of the plurality of other operating systems in a second data structure of a second shared memory through the first operating system, wherein the ready-to-send flag bit bit is configured to identify whether there is command data to be sent by a corresponding other operating system.

At S52, when it is detected that the ready-to-send flag bit corresponding to the second operating system is a first value, determining that there is command data to be sent by the second operating system, wherein the first value is configured to indicate that there is command data to be sent by a corresponding other operating system.

For the second operating system, after writing the command data to be sent to the first shared memory, the second operating system can set the ready-to-send flag bit corresponding to the second operating system in the second data structure of the second shared memory to the first value, so as to indicate that the command data to be sent in the first shared memory is valid (i.e., there is command data to be sent by the second operating system). A write mode of the first shared memory can be to write to the first data structure in the first shared memory, and those that have already been described are not described herein again.

The first operating system can detect the ready-to-receive flag bit corresponding to each of other operating systems (including the second operating system) in the second data structure, and the detection can be performed in a manner of polling, or there can also be other detection modes. If it is detected that the ready-to-send flag bit corresponding to the second operating system is the first value, the first operating system determines that there is command data to be sent by the second operating system. For example, the command data that is stored in the first data structure and corresponds to the system identifier of the second operating system is valid, and in this case, the first operating system can execute the operation of acquiring the command data to be sent by the second operating system.

For example, the Linux system of the Core partition 2 sets the sending Ready flag bit of the Core partition 2 to 1 (the flag bit is stored in a specific region of the shared memory), the Linux system of the Core partition 1 detects the sending Ready flag bit of each Core partition in a polling manner, when it is detected that the flag bit is 1, data reading is performed, and then the read data is analyzed and then recombined, and converted into the Ping command message and sent to the PECI bus.

Through this embodiment, the sending flag bit in a specific data structure is set to indicate that there is command data to be sent by the corresponding operating system, such that the convenience of information transmission can be improved.

In an exemplary embodiment, after acquiring the command data to be sent by the second operating system through the first operating system, the method further includes the following step.

At S61, setting the ready-to-send flag bit corresponding to the second operating system to a second value through the first operating system, wherein the second value is configured to indicate that there is no command data to be sent by a corresponding other operating system.

After the command data to be sent by the second operating system is acquired, since in the second data structure, a value of the ready-to-send flag bit corresponding to the second operating system is the first value, in order to avoid an information processing error caused by the repeated reading of the same command data, the ready-to-send flag bit corresponding to the second operating system in the second data structure can be set to the second value after the first operating system acquires the command data to be sent by the second operating system.

Here, in the second data structure, the ready-to-send flag bit corresponding to each operating system is set to the first value by the operating system, and set to the second value by the first operating system, such that the accuracy and timeliness of the ready-to-send flag bit can be improved, thereby avoiding the information processing error.

For example, the Linux system of the Core 1 analyzes and recombines the read data, and converts same into the Ping command message and send same to the PECI bus, and the Linux system of the Core partition 1 eliminates the above flag bit, and waits for next data transmission.

Through this embodiment, after the command data is read, a specified operating system modifies a value of the ready-to-receive flag bit corresponding to the operating system, such that the accuracy and timeliness of the ready-to-send flag bit can be improved, thereby avoiding the information processing error.

In an exemplary embodiment, recombining the command data to be sent through the first operating system, to obtain the target command message corresponding to the command data to be sent includes the following steps.

At S71, determining a command type corresponding to the command data to be sent to obtain a target command type, wherein the target command type is a command type of a preset command used to send the command data to be sent.

At S72, recombining the command data to be sent according to a command format corresponding to the target command type, to obtain the target command message corresponding to the command data to be sent.

The command formats corresponding to different command types are different. In order to adapt to different command types, the first operating system can determine the command type corresponding to the command data to be sent, so as to obtain the target command type. The target command type is a command type of a preset command used for sending the command data to be sent. The manner of determining the command type corresponding to the command data to be sent can be determined based on a command type identifier extracted from the command data to be sent, or can also be determined by other manners, and this embodiment is not limited thereto.

After the target command type is determined, the command data to be sent is recombined according to a command format corresponding to the target command type, such that the target command message corresponding to the command data to be sent can be obtained. Here, data recombination can be executed by an interface controller (e.g., PECI controller) of the target communication interface, or can also be executed by the first operating system. Furthermore, the command data to be sent itself can also be a command message that can be sent on the target communication bus, and processing requirements for different operating systems can be reduced by executing a recombination operation of the command messages by the first operating system (or the interface controller of the target communication interface of the first operating system).

Through this embodiment, the processing requirements for different operating systems can be reduced by executing the recombination from the command data to the command message according to the command type by the specified operating system or the interface controller of the specified operating system. In an exemplary embodiment, in the at least two operating systems, there are a plurality of other operating systems other than the first operating system. The command data to be sent can directly carry a destination address (e.g., a communication address of the target hardware partition system). In order to reduce a data volume required to be transmitted between the operating systems, only the system identifier of the operating system can be transmitted between the operating systems, and the destination address is determined by the first operating system based on the system identifier. For this purpose, a difference value between a communication address of a hardware partition system corresponding to each of other operating systems and a communication address of a hardware partition system corresponding to the first operating system can be configured to have a specified correspondence relationship with a difference value between a system identifier of each of other operating systems and a system identifier of the first operating system, such that the destination address can be directly determined based on the system identifier. Correspondingly, before recombining the command data to be sent through the first operating system, the method further includes the following step.

At S81, determining a communication address of the target hardware partition system corresponding to the second operating system through the first operating system according to the specified correspondence relationship, a difference value between a system identifier of the first operating system and a system identifier of the second operating system, and a communication address of a hardware partition system corresponding to the first operating system.

When the command data to be sent is recombined, the first operating system can determine the communication address of the target hardware partition system according to the specified correspondence relationship, the difference value between the system identifier of the first operating system and the system identifier of the second operating system, and the communication address of the hardware partition system corresponding to the first operating system. The specified correspondence relationship here can be an equality relationship, or can also be other relationships, which is not limited herein.

For example, a PECI address of the Core partition 1 is 0x30, a command message to be sent is the Core partition 2, and the destination address is determined as 0x30 plus (partition number-1). Through this embodiment, the destination address can be determined based on the system identifier, such that a data volume required for transmission of the command data between the systems can be reduced, thereby improving the efficiency of data transmission.

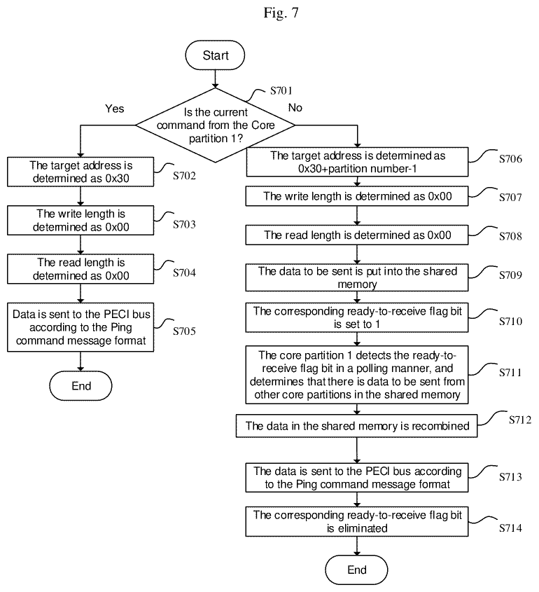

The manner of sending the command message based on the system architecture shown in FIG. 3 is explained and described below in combination with optional examples. In this optional example, the PECI command (namely, the current command) is the Ping command. Correspondingly, as shown in FIG. 7, the sending flow of the Ping command can include the following steps.

At S701, the Linux system of the Core partition 1 determines whether the current command from the Core partition 1, and if so, S702 is executed, otherwise, S706 is executed.

At S702, the target address is determined as 0x30.

At S703, the write length is determined as 0x00.

At S704, the read length is determined as 0x00.

At S705, data is sent to the PECI bus according to the Ping command message format.

At S706, the target address is determined as 0x30+partition number-1.

At S707, the write length is determined as 0x00.

At S708, the read length is determined as 0x00.

At S709, the Linux systems of other Core partitions other than the Core partition 1 put the data to be sent into the shared memory.

At S710, the corresponding sending Ready flag bit is set to 1.

At S711, the Linux system of the Core partition 1 detects the sending Ready flag bit in a polling manner, and confirms that there is data to be sent from other Core partitions (the Core partitions other than the Core partition 1) in the shared memory.

At S712, after it is confirmed that there is data to be sent from other Core partitions in the shared memory, the data in the shared memory is recombined.

At S713, the data is sent to the PECI bus according to the Ping command message format.

At S714, the Linux system of the Core partition 1 eliminates the corresponding sending Ready flag bit, and waits for a next round of data transmission.

Through this optional example, the sending flow of the PECI command under the hardware partition system, as well as the designing of the sending Ready flag bit based on the shared memory, the definition of the send data structure, are provided, such that a function of sending the PECI command by different Core partitions of a BMC management unit can be achieved.

In an exemplary embodiment, after sending the target command message onto the target communication bus through the target communication interface of the first operating system, the method further includes the following steps.

At S91, receiving a target response message on the target communication bus through the first operating system, wherein the target response message is response data returned by the target hardware partition system in response to the target command message, and the target response message carries a communication address of the target hardware partition system.

At S92, determining that the target response message is a response message to be sent to the second operating system according to the communication address of the target hardware partition system through the first operating system, and sending the target response message to the second operating system through the first operating system.

In this embodiment, the target command message can be a command message that instructs the target hardware partition system to execute a specific operation, for example, a command that is used for the BMC on the target communication bus as a host device to confirm whether there is a corresponding hardware partition system as a client device, for example, the Ping command. Here, the Ping command is a command that is used for the Host device on the PECI bus to confirm whether there is a corresponding Client device. The target hardware partition system can respond to the target command message after acquiring the target command message, and returns a response message, which is a target response message, of the target command message to the second operating system, and the target response message is sent onto the target communication bus by the target hardware partition system.

For example, for the receiving and issuing process of the PECI data, address information comparison is performed after the PECI controller of each partition system of the Host side receives the command data on the PECI bus. When a PECI address (i.e., a PECI address in the command data) on the PECI bus matches itself, the command is received, and the response data is sent onto the PECI bus.

By using the Ping command as an example, for a first situation (the Core partition 1 of the BMC sends the PECI data), a PECI controller (PECI 1 in FIG. 3) of a CPU in the hardware partition 1 of the Host side successfully matches the target address on the PECI bus, and sends a Frame Check Sequence (FCS, used for the Client device in the PECI bus to respond to verification information of the Host device) to the PECI bus as the response data. For a second situation (the Core partition 2 of the BMC sends the PECI data), a PECI controller (PECI 2 in FIG. 3) of a CPU in the hardware partition 2 of the Host side successfully matches the target address on the PECI bus, and sends the FCS to the PECI bus as the response data.

It is to be noted that, based on different types of the command messages, there is difference in whether a response message is returned and a type of the returned message. For example, for the command message acquiring one or more operating parameters, the response message carrying corresponding parameter information is returned, and for the command message that instructs the hardware partition system to execute a system operation, the response message can not be returned, or the response message carrying an operation execution result is returned. The optional command message and the corresponding response messages can be referred to the related technologies, and this embodiment is not described thereto.

On the BMC side, since the target communication interface is configured to the first operating system, the first operating system can process the response message on the target communication bus, and it not only processes the response message returned to itself, but also processes the response message returned to other operating systems on the same BMC. For the target command message, the first operating system can receive the target response message on the target communication bus. The target response message carries the communication address of the target hardware partition system, and based on the communication address of the target hardware partition system, the target response message is determined as the response message of the second operating system. In this case, the first operating system can issue the target response message to the second operating system.

Optionally, a communication address of one operating system and the communication address of the corresponding hardware partition system can be the same, such that the communication address of the hardware partition system can be used as the communication address of the corresponding operating system. Furthermore, a corresponding communication address can also be virtualized for other operating systems other than the first operating system, and in this case, the target address (i.e., the communication address of the operating system) carried in the target response message is a virtual communication address of the second operating system.

For example, the PECI controller of the Core partition 1 of the BMC side can receive the response data on the PECI bus. If the current PECI address corresponds to the Core partition 1, the Linux system of the Core partition 1 processes the response data; and if the PECI address corresponds to the Core 2-Core N, the Linux system of the Core partition 1 can issue the response data to the Linux system of the corresponding Core partition.

By using the Ping command as an example, for the first situation, the Linux system of the Core partition 1 of the BMC side first receives the FCS on the bus through the PECI, and then determines the value of the PECI address, which is found to be 0x30 (the target address in the first situation is 0x30), indicating that the FCS is the response data that is issued to the Core partition 1 of the BMC side by the hardware partition (namely, hardware partition system) 1 of the Host side, and in this case, the Linux system of the Core partition 1 compares the FCS with a locally-computed FCS, and if the FCSes are equal, the Ping command is successfully returned, otherwise, it indicates that there is an abnormal situation.

For the second situation, the Linux system of the Core partition 1 of the BMC side first receives the FCS on the bus through the PECI, and then determines the value of the PECI address, which is found to be 0x31 (the target address in the second situation is 0x31), indicating that the FCS is the response data that is issued to the Core partition 2 of the BMC side by the hardware partition 2 of the Host side, and in this case, the Linux system of the Core partition 1 performs data distribution on the FCS.

It is to be noted that, the first operating system can directly issue the target response message to the second operating system, or can also issue partial data (e.g., valid data) in the target response message to the second operating system. The manner of distributing the response data can be inter-core communication or other manners that can perform data interaction between the operating systems on different processor cores of the same BMC, and this embodiment is not limited thereto.

Through this embodiment, the accuracy and success rate of message interaction can be improved by executing the receiving and issuing of the response message by the operating system to which the communication interface of the BMC is distributed.

In an exemplary embodiment, sending the target response message to the second operating system through the first operating system includes the following step.

At S101, writing target response data in the target response message to a third shared memory through the first operating system such that the second operating system reads the target response data from the third shared memory, wherein the third shared memory is configured to store response data that is sent to other operating systems in the at least two operating systems other than the first operating system.

In this embodiment, the response message can be issued to the corresponding operating system through the third shared memory. The third shared memory is a shared memory of the at least two operating systems, and can be configured to store the response data sent to other operating systems in the at least two operating systems other than the first operating system. Each of the at least two operating systems is allowed to access the shared memory. Operation permissions of different operating systems to the third shared memory can be the same, or can also be different. For example, the first operating system can have a read-write permission of the third shared memory, and other operating systems have a read permission of the third shared memory. Optionally, the third shared memory and the first shared memory and/or the second shared memory can be the same, or can also be different, and this embodiment is not limited thereto.

For the target response message, the first operating system can write the target response message or the target response data in the target response message to the third shared memory, and the second operating system can read the target response data from the third shared memory by accessing the third shared memory, thereby completing the issuing of the target response message.

For example, for the response data of other Core partition is, the Linux system of the Core partition 1 can write the response data to the shared memory, such that the Linux system of the corresponding Core partition reads the response data from the shared memory. By using the Ping command as an example, for the second situation, the Linux system of the Core partition 1 writes the FCS to the shared memory.

Through this embodiment, data transmission is performed among different operating systems of the same BMC through the shared memory, such that the flexibility of data transmission can be improved, and requirements for the real-time performance of data transmission are reduced at the same time.

In an exemplary embodiment, writing target response data in the target response message to the third shared memory through the first operating system includes the following step.

At S111, writing the target response data to a third data structure of the third shared memory according to a system identifier of the second operating system through the first operating system, wherein the third data structure is configured to store the response data to be sent to the other operating systems by using at least one specified parameter according to system identifiers of the other operating systems, and the response data sent to the other operating systems comprises parameter information of the at least one specified parameter corresponding to the other operating systems.

In this embodiment, the response data sent to other operating systems can be stored by the third data structure of the third shared memory. Through the special designing of the data structure, it can indicate which operating system (e.g., Core partition) the response data belongs to, for example, that the response data is the response data sent to the Core partition 2 is indicated through the special designing of the data structure in the shared memory. In the third data structure, the response data sent to other operating systems can be stored by using at least one specify parameter according to the system identifiers of other operating systems, and the response data sent to other operating systems includes parameter information of the at least one specify parameter corresponding to other operating systems.

Here, the at least one specify parameter can be one or more parameters that are preset and can be adapted to different types of response data. In order to avoid waste of storage space caused by excessive set parameters, the at least one specify parameter can include common parameters in various response data and a parameter that adapts to other non-common parameters. Exemplarily, the at least one specify parameter includes one of the following: a verification sequence generated by the hardware partition system sending the response data, valid data in the response data, or a verification sequence received by the hardware partition system sending the response data. Furthermore, the third data structure can not store the system identifier, and only includes the at least one specify parameter, as long as a correspondence relationship between each operating system and a storage position (e.g., a start position, a space size, etc.) of the response data sent to each operating system is configured.

Optionally, a storage sequence of parameter information of the at least one specify parameter can be pre-configured, and can be adjusted based on configuration. In the third data structure, the response data sent to each operating system can be stored in a variety of ways, which can include, but are not limited to, at least one of the following storage modes: the response data is successively continuously stored with the parameter information of the at least one specify parameter corresponding to the same other operating system; or in the third data structure, the response data is successively continuously stored with the parameter information of the same specify parameter in the at least one specify parameter corresponding to the plurality of other operating systems, for can also be stored in other ways, and this embodiment is not limited thereto.

For example, definitions of the data structures of the data received by the Core 2-Core 8 of the BMC side can be shown in Table 3.

TABLE 3

| Serial | Variable | Variable | |
|---|---|---|---|
| number | name | type | Description |
| 1 | CoreNum | unsigned | Indicate Core partition number to which |
| | (optional) | char | the data is sent |
| 2 | FCS1 | unsigned | Verification sequence sending data |
| | | char | |
| 3 | Data | unsigned | Received valid data |
| | | char[30] | |
| 4 | FCS2 | unsigned | Verification sequence receiving data |
| | | char | |

The verification sequence sending the data is a verification sequence (this variable is an optional variable) carried in a command message received by a partition system, and the verification sequence receiving the data is a verification sequence generated by the partition system.

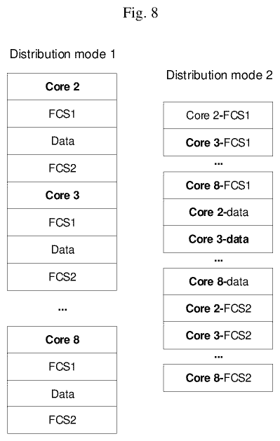

A distribution mode of the data structure in the memory can be shown in FIG. 8. FIG. 8 shows two possible distribution modes. In addition to the distribution mode shown in FIG. 8, there can also be other distribution modes, which are not enumerated one by one herein.

For the target response data, the first operating system can write the target response data to the third data structure of the third shared memory according to the system identifier of the second operating system. A write manner can include: based on the target response data, parameter information of each of the at least one specify parameter is determined; based on the system identifier of the second operating system, a storage position of the parameter information of each specify parameter corresponding to the second operating system in the third data structure is determined; and the determined parameter information of each specify parameter is written to the corresponding storage position.

Through this embodiment, which operating system the response data belongs to is indicated through the special designing of the data structure, such that the accuracy of data transmission can be improved.

In an exemplary embodiment, there are a plurality of other operating systems, that is, the system identifier of each of the at least two operating systems is continuously arranged. For a scenario in which each operating system operates on one core partition, a serial number of the core partition can be used as the system identifier of the operating system operated. In the third data structure, the response data sent to the plurality of operating systems is stored according to a sequence of the system identifiers of the plurality of other operating systems, for example, a distribution mode 1 is shown in FIG. 8.

Correspondingly, writing the target response data to the third data structure of the third shared memory according to the system identifier of the second operating system through the first operating system includes the following step.

At S121, writing the target response data to a storage position corresponding to the system identifier of the second operating system in the third data structure through the first operating system.

For the situation that the response data sent to each of other operating systems is stored according to the sequence of the system identifiers of the plurality of other operating systems, the storage position of the response data sent to each of other operating systems is fixed. In this case, the storage position of the target response data can be determined by traversing the third data structure (e.g., after the system identifier of the second operating system is found, the storage position of the target response data is determined based on a relationship between the at least one specify parameter and the storage position of the system identifier), or the target response data can also be directly written to the storage position corresponding to the system identifier of the second operating system in the third data structure, thereby improving the efficiency of data writing.

Through this embodiment, the efficiency of data storage can be improved by directly storing the response data based on the correspondence relationship between the system identifier and the storage position of the corresponding response data.

In an exemplary embodiment, similar to the foregoing embodiments, there can be a plurality of other operating systems in the at last two operating systems. In this case, a fourth data structure can be pre-defined. A ready-to-receive flag bit (a receiving Ready flag bit or referred as a data receiving Ready flag bit) corresponding to each of other operating systems can be set in the data structure, so as to identify whether there is response data sent to the corresponding operating system. When the ready-to-receive flag bit is a third value (e.g., 1 or 0), it indicates that there is response data sent to the corresponding operating system; and when the ready-to-receive flag bit is a fourth value (e.g., 0 or 1), it indicates that there is no response data sent to the corresponding operating system. The ready-to-receive flag bit corresponding to the operating system to which the response message is sent to by the first operating system based on the received response data facilitates the informing of the presence of the response data sent to the operating system in the operating system.

For example, definitions of the data structures of the receiving Ready flag bit of the Core 2-Core 8 of the BMC side is shown in Table 4.

TABLE 4

| Serial | | Variable | |
|---|---|---|---|
| number | Variable name | type | Description |
| 1 | Rx_Rdy_Flg | unsigned | A bit wide is 8 bits, the top digit is invalid, the lower 7 bits |
| | | char | respectively correspond to the Core 2-Core 8 partitions, when |
| | | | each bit is 1, it indicates that data received by the corresponding Core |
| | | | partition in the shared memory is valid, and when each bit is 0, it indicates |
| | | | that the data received by the corresponding Core partition in the shared |
| | | | memory is invalid. |

Here, the data structures in Table 2 and Table 4 can be the same data structure, that is, the same data structure stores variable information of two variables, which are Tx_Rdy_Flg and Rx_Rdy_Flg.

Correspondingly, after writing target response data in the target response message to the third shared memory through the first operating system, the method further includes the following steps.

At S131, setting a ready-to-receive flag bit corresponding to the second operating system in a fourth data structure of a fourth shared memory to a third value through the first operating system, wherein the ready-to-receive flag bit bit is configured to identify whether there is response data that is sent to a corresponding operating system, and the third value is configured to indicate that there is response data that is sent to a corresponding operating system.

At S132, detecting the ready-to-receive flag bit corresponding to the second operating system in the fourth data structure through the second operating system.

At S133, when detecting that the ready-to-receive flag bit corresponding to the second operating system is the third value, reading the target response data from the third shared memory through the second operating system.

For the target response data, the first operating system can set the ready-to-receive flag bit corresponding to the second operating system in the fourth data structure of the fourth shared memory to the third value. Here, the fourth shared memory can be the same shared memory as the first shared memory, the second shared memory, and/or the third shared memory, or can also be a different shared memory. The fourth data structure can be the same data structure as the second data structure, or can also be a different data structure, and this embodiment is not limited thereto.

The second operating system can detect the ready-to-receive flag bit corresponding to the second operating system in the fourth data structure, and the detection can be performed in a manner of polling, or there can also be other detection modes. If it is detected that the ready-to-receive flag bit corresponding to the second operating system is the third value, the second operating system determines that there is response data sent to the second operating system. For example, the response data that is stored in the third data structure and corresponds to the system identifier of the second operating system is valid, and in this case, the second operating system can read the target response data from the third shared memory.

The manner of reading the target response data from the third shared memory is similar to that in the foregoing embodiments, and is not described herein again.

For example, the data receiving Ready flag bit corresponding to the Core partition can be set to 1.

The Linux system of each Core partition detects the data Ready flag bit through polling (the Linux systems of different Core partitions respectively detect the data Ready flag bits corresponding to themselves). If it is found that the flag bit corresponding to the current partition is set to 1, the corresponding response data is read from the shared memory.

By using the Ping command as an example, for the second situation, after the data is written, the Core partition 1 sets the receiving Ready flag bit corresponding to the Core partition 2 to 1. The Linux system of the Core partition 2 detects the receiving Ready flag bit of itself in a polling manner, finding that the flag bit is 1, and the data is read from the corresponding shared memory.

Through this embodiment, the sending flag bit in a specific data structure is set to indicate that there is response data sent to the operating system in the corresponding operating system, such that the convenience of information transmission can be improved.

In an exemplary embodiment, after reading the target response data from the third shared memory through the second operating system, the method further includes the following step.

At S141, setting the ready-to-receive flag bit corresponding to the second operating system in the fourth data structure to a fourth value through the second operating system, wherein the fourth value is configured to indicate that there is no response data that to be sent to a corresponding operating system.

After the response data is read from the third shared memory, since in the fourth data structure, a value of the ready-to-receive flag bit corresponding to the second operating system is the third value, in order to avoid an information processing error caused by the repeated reading of the same response data, the ready-to-receive flag bit corresponding to the second operating system in the fourth data structure can be set to the fourth value after the second operating system acquires the target response data.

Here, in the fourth data structure, the ready-to-receive flag bit corresponding to each operating system is set to the third value by the first operating system, and set to the fourth value by the operating system, such that the accuracy and timeliness of the ready-to-receive flag bit can be improved, thereby avoiding the information processing error.

For example, the Linux system of one Core partition eliminates the flag bit (i.e., the flat is set to 0) after reading the data, and finally, the Linux system further processes the read data. By using the Ping command as an example, for the second situation, after the data is written, the Core partition 1 sets the data receiving Ready flag bit corresponding to the Core partition 2 to 1. The Linux system of the Core partition 2 detects the flag bit in a polling manner, finding that the flag bit is 1, and the data is read from the corresponding shared memory. After the data is read, the flag bit is eliminated, the FCS in the data is further compared with a locally-computed sequence, if the sequences are equal, it indicates that the Ping command is successfully returned, otherwise, it indicates that there is an abnormal situation.

Through this embodiment, after the response data is read, the operating system to which the response data is sent modifies a value of the ready-to-receive flag bit corresponding to the operating system, such that the accuracy and timeliness of the ready-to-receive flag bit can be improved, thereby avoiding the information processing error.

In an exemplary embodiment, sending the target response message to the second operating system through the first operating system includes the following step.

At S151, sending a second inter-core communication request to the second operating system through the first operating system, wherein the second inter-core communication request carries target response data in the target response message.

In this embodiment, the response data can also be transmitted by using an existing inter-core communication request or a newly-defined inter-core communication request. Here, the newly-defined inter-core communication request can be an inter-core communication request based on an existing inter-core communication protocol, or can also be an inter-core communication request based on a new inter-core communication protocol, which is not limited thereto in this embodiment, as long as the response data can be transmitted through the inter-core communication request.

For the target response message or the target response data in the target response message, the first operating system can send the second inter-core communication request to the second operating system. The inter-core communication request carries the target response message or the target response data in the target response message.

Through this embodiment, the timeliness of response data transmission can be improved by using the inter-core communication request to transmit the response data.

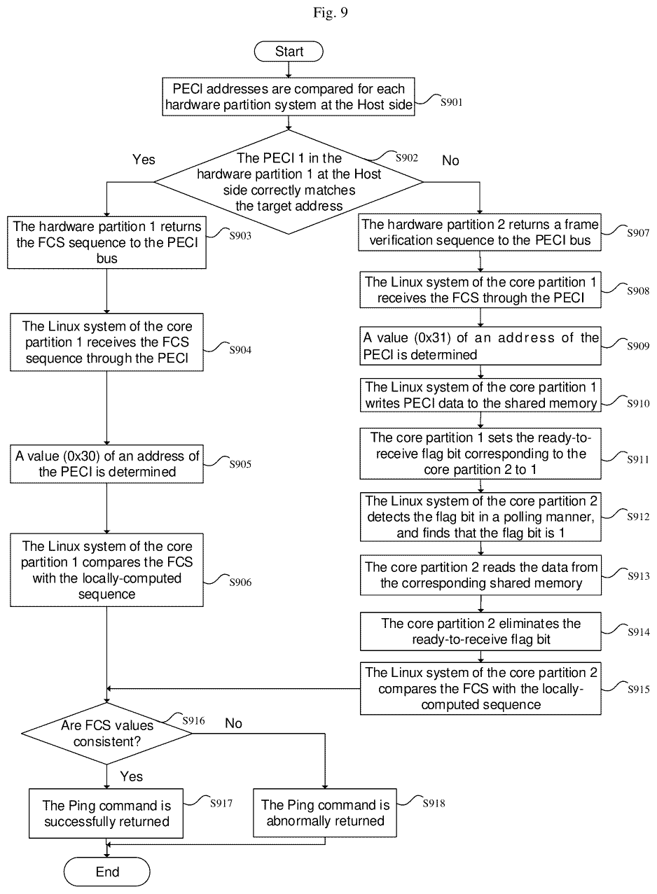

The manner of receiving and issuing the command message based on the system architecture shown in FIG. 9 is explained and described below in combination with optional examples. In this optional example, the PECI command is the Ping command. Correspondingly, as shown in FIG. 9, the receiving and issuing flow of the Ping command can include the following steps.

At S901, PECI addresses are compared for each hardware partition system at the Host side.

At S902, it is determined that the PECI 1 in the hardware partition 1 at the Host side correctly matches the target address on the PECI bus; and if so, S903 is executed, otherwise, S907 is executed.

At S903, the hardware partition 1 returns the FCS sequence as the response data, and sends same to the PECI bus.

At S904, the Linux system of the Core partition 1 receives the FCS sequence on the PECI bus through its PECI.

At S905, a value of the PECI address is determined, which is found to be 0x30, indicating that the FCS is the response data that is issued to the Core partition 1 of the BMC side by the hardware partition 1 of the Host side.

At S906, the Linux system of the Core partition 1 compares the FCS with the locally-computed sequence.

At S907, the PECI 2 in the hardware partition 2 successfully matches the target address on the PECI bus, and the FCS is returned as the response data and sent to the PECI bus.

At S908, the Linux system of the Core partition 1 receives the FCS on the bus through PECI.

At S909, the Linux system of the Core partition 1 determines the value of the PECI address, which is found to be 0x31, indicating that the FCS is the response data that is issued to the Core partition 2 of the BMC side by the hardware partition 2 of the Host side.

At S910, the Linux system of the Core partition 1 writes PECI data to the shared memory.

At S911, after the data is written, the Core partition 1 sets the data receiving Ready flag bit corresponding to the Core partition 2 to 1.

At S912, the Linux system of the Core partition 2 detects the flag bit in a polling manner, and finds that the flag bit is 1.

At S913, the Core partition 2 reads the data from the corresponding shared memory.

At S914, after the data is read, the Core partition 2 eliminates the data Ready flag bit.

At S915, the Core partition 2 compares the FCS with the locally-computed sequence.

At S916, whether the FCS values are consistent is determined, if so, S917 is executed, otherwise, S918 is executed, and here, S916 is executed after S906 or S915.

At S917, the Ping command is successfully returned.

At S918, the Ping command is abnormally returned.

Through this optional example, the receiving and issuing flow of the PECI command under the hardware partition system, as well as the designing of the receiving Ready flag bit based on the shared memory, the definition of the receiving data structure, are provided, such that a function of receiving the PECI command by different Core partitions of a BMC management unit can be achieved.

It is to be noted that, for ease of simple description, the foregoing method embodiments are all expressed as a series of action combinations, but those skilled in the art should know that the present disclosure is not limited by the described action sequence, as according to the present disclosure, some steps can be performed in other sequences or simultaneously. Then, those skilled in the art should also know that the embodiments described in the specification are all optional embodiments, and the actions and modules involved are not necessarily required by the present disclosure.

Another aspect of the embodiments of the present disclosure further provides an apparatus for controlling communication based on a hardware partition system. The apparatus can be applied to a server including a BMC and a host system. The BMC communicates with the host system through a target communication bus, at least two operating systems are operated on a multi-core processor of the BMC, the host system is divided into a plurality of hardware partition systems, one of the at least two operating systems is configured to monitor an operating state of at least one of the plurality of hardware partition systems, a target communication interface of the BMC is configured to a first operating system in the at least two operating systems, and the target communication interface is a communication interface corresponding to the target communication bus. Optionally, the apparatus is configured to implement the method for controlling communication based on a hardware partition system provided in the embodiments, and the descriptions that have already been performed are not described herein again. As used below, the term “module” can be a combination of software and/or hardware that implements a predetermined function. Although the apparatus described in the following embodiments is preferably implemented in software, but implementations in hardware, or a combination of software and hardware, are also possible and conceived.

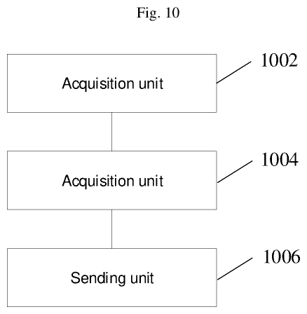

FIG. 10 is a block structural diagram of an apparatus for controlling communication based on a hardware partition system according to embodiments of the present disclosure. As shown in FIG. 10, the apparatus includes: an acquisition unit 1002, configured to acquire command data to be sent by a second operating system through the first operating system, wherein the second operating system is any one of the at least two operating systems other than the first operating system; a recombination unit 1004, configured to recombine the command data to be sent through the first operating system, to obtain a target command message corresponding to the command data to be sent, wherein a target address in the target command message is a communication address of a target hardware partition system corresponding to the second operating system within the plurality of hardware partition systems; and a sending unit 1006, configured to send the target command message onto the target communication bus through the target communication interface of the first operating system such that the target hardware partition system receives the target command message on the target communication bus through a target communication interface of the target hardware partition system.

Through the embodiments of the present disclosure, the command data to be sent by the second operating system is acquired through the first operating system, where the second operating system is any operating system in the at least two operating systems other than the first operating system; the command data to be sent is recombined through the first operating system, so as to obtain the target command message corresponding to the command data to be sent, where the target address in the target command message is the communication address of the target hardware partition system corresponding to the second operating system; and the target command message is sent onto the target communication bus through the target communication interface of the first operating system such that the target hardware partition system receives the target command message on the target communication bus through the target communication interface of the target hardware partition system. Therefore, the problem of poor monitoring effectiveness for a plurality of partition systems in the methods for monitoring a server fault and a state of a server system through a server management unit in the related art can be solved, thereby improving the effectiveness of the monitoring of the partition systems.

In an exemplary embodiment, the acquisition unit includes an acquisition module, which is configured to, when it is determined that there is the command data to be sent by the second operating system, acquire the command data to be sent from a first shared memory through the first operating system, wherein the first shared memory is configured to store command data to be sent by the other operating systems in the at least two operating systems other than the first operating system.

In an exemplary embodiment, the acquisition module includes an acquisition sub-unit, which is configured to, when it is determined that there is the command data to be sent by the second operating system, acquire the command data to be sent from a first data structure of the first shared memory according to a system identifier of the second operating system through the first operating system, wherein the first data structure is configured to store command data to be sent by the other operating systems by using at least one command parameter according to system identifiers of the other operating systems, and the command data to be sent by the other operating systems comprises parameter information of the at least one command parameter corresponding to the other operating systems.

In an exemplary embodiment, the other operating systems comprise a plurality of other operating systems, system identifiers of the at least two operating systems are continuously arranged, the first data structure is configured to sequentially store the command data to be sent by each other operating system in the plurality of other operating systems according to a sequence of the system identifiers of the plurality of other operating systems, and a storage space occupied by the command data to be sent by each of other operating systems is pre-assigned. Correspondingly, the acquisition sub-unit includes an acquisition sub-module, which is configured to, when it is determined that there is the command data to be sent by the second operating system, acquire the command data to be sent from a storage position corresponding to the system identifier of the second operating system in the first data structure through the first operating system.

In an exemplary embodiment, the at least one command parameter comprises at least one of the following: a write length, a read length, a command code, a write parameter; in the first data structure, the parameter information of the at least one command parameter corresponding to the same other operating system is sequentially continuously stored; or in the first data structure, the parameter information of the same command parameter in the at least one command parameter corresponding to the plurality of other operating systems is sequentially continuously stored.

In an exemplary embodiment, the acquisition unit includes a first receiving unit, which is configured to receive a first inter-core communication request sent by the second operating system through the first operating system, wherein the first inter-core communication request carries the command data to be sent.

In an exemplary embodiment, in the at least two operating systems, there are a plurality of other operating systems other than the first operating system. The apparatus further includes: a first detection unit, configured to sequentially detect a ready-to-send flag bit corresponding to each other operating system of the plurality of other operating systems in a second data structure of a second shared memory through the first operating system, wherein the ready-to-send flag bit is configured to identify whether there is command data to be sent by a corresponding other operating system; and a first determination unit, configured to, when it is detected that the ready-to-send flag bit corresponding to the second operating system is a first value, determine that there is command data to be sent by the second operating system, wherein the first value is configured to indicate that there is command data to be sent by a corresponding other operating system.

In an exemplary embodiment, the apparatus further includes a first execution unit, which is configured to, after acquiring the command data to be sent by the second operating system through the first operating system, set the ready-to-send flag bit corresponding to the second operating system to a second value through the first operating system, wherein the second value is configured to indicate that there is no command data to be sent by a corresponding other operating system.

In an exemplary embodiment, the recombination unit includes: a determination module, configured to determine a command type corresponding to the command data to be sent to obtain a target command type, wherein the target command type is a command type of a preset command used to send the command data to be sent; and a recombination module, configured to recombine the command data to be sent according to a command format corresponding to the target command type, to obtain the target command message corresponding to the command data to be sent.

In an exemplary embodiment, in the at least two operating systems, there are a plurality of other operating systems other than the first operating system, and a difference value between a communication address of a hardware partition system corresponding to each of the plurality of other operating systems and a communication address of a hardware partition system corresponding to the first operating system has a specified correspondence relationship with a difference value between a system identifier of each of the plurality of other operating systems and a system identifier of the first operating system. The apparatus further includes a second determination unit, which is configured to, before recombining the command data to be sent through the first operating system, a communication address of the target hardware partition system corresponding to the second operating system through the first operating system according to the specified correspondence relationship, a difference value between a system identifier of the first operating system and a system identifier of the second operating system, and a communication address of a hardware partition system corresponding to the first operating system.

In an exemplary embodiment, the apparatus further include: a second receiving unit, configured to, after sending the target command message onto the target communication bus through the target communication interface of the first operating system, a target response message on the target communication bus through the first operating system, wherein the target response message is response data returned by the target hardware partition system in response to the target command message, and the target response message carries a communication address of the target hardware partition system; and a second execution unit, configured to determine that the target response message is a response message to be sent to the second operating system according to the communication address of the target hardware partition system through the first operating system, and sending the target response message to the second operating system through the first operating system.

In an exemplary embodiment, the second execution unit includes an execution module, which is configured to write target response data in the target response message to a third shared memory through the first operating system such that the second operating system reads the target response data from the third shared memory, wherein the third shared memory is configured to store response data that is sent to other operating systems in the at least two operating systems other than the first operating system.

In an exemplary embodiment, the execution module includes a write sub-unit, which is configured to write the target response data to a third data structure of the third shared memory according to a system identifier of the second operating system through the first operating system, wherein the third data structure is configured to store the response data to be sent to the other operating systems by using at least one specified parameter according to system identifiers of the other operating systems, and the response data sent to the other operating systems comprises parameter information of the at least one specified parameter corresponding to the other operating systems.

In an exemplary embodiment, the other operating systems comprise a plurality of other operating systems, system identifiers of the at least two operating systems are continuously arranged, the third data structure is configured to sequentially store the response data to be sent to each other operating system in the plurality of other operating systems according to a sequence of system identifiers of the plurality of other operating systems. The write sub-unit includes a write sub-module, which is configured to write the target response data to a storage position corresponding to the system identifier of the second operating system in the third data structure through the first operating system.

In an exemplary embodiment, the at least one specified parameter comprises at least one of the following: a verification sequence generated by a hardware partition system sending the response data, valid data in the response data, a verification sequence received by the hardware partition system sending the response data; in the third data structure, the parameter information of the at least one specified parameter corresponding to the same other operating system is sequentially continuously stored; or in the third data structure, the parameter information of the same specified parameter in the at least one specified parameter corresponding to the plurality of other operating systems is sequentially continuously stored.

In an exemplary embodiment, in the at least two operating systems, there are a plurality of other operating systems. The apparatus further includes: a third execution unit, configured to, after writing target response data in the target response message to the third shared memory through the first operating system, set a ready-to-receive flag bit corresponding to the second operating system in a fourth data structure of a fourth shared memory to a third value through the first operating system, wherein the ready-to-receive flag bit is configured to identify whether there is response data that is sent to a corresponding operating system, and the third value is configured to indicate that there is response data that is sent to a corresponding operating system; a second detection unit, configured to detect the ready-to-receive flag bit corresponding to the second operating system in the fourth data structure through the second operating system; and a read unit, configured to, when detecting that the ready-to-receive flag bit corresponding to the second operating system is the third value, read the target response data from the third shared memory through the second operating system.

In an exemplary embodiment, the apparatus further include a fourth execution unit, which is configured to, after reading the target response data from the third shared memory through the second operating system, set the ready-to-receive flag bit corresponding to the second operating system in the fourth data structure to a fourth value through the second operating system, wherein the fourth value is configured to indicate that there is no response data that to be sent to a corresponding operating system.

In an exemplary embodiment, the second execution unit includes a sending module, which is configured to send a second inter-core communication request to the second operating system through the first operating system, wherein the second inter-core communication request carries target response data in the target response message.

In an exemplary embodiment, the target communication bus is a Platform Environment Control Interface (PECI) bus, and the target communication interface is a PECI; and a communication between one operating system of the at least two operating systems and a hardware partition system corresponding to the one operating system is initiated by the one operating system as a host device to the hardware partition system corresponding to the one operating system as a client device, and the PECI of the BMC is allocated to the first operating system through only allowing the first operating system to access a PECI controller of the BMC.

It is to be noted that, each of the above modules can be implemented by software or hardware. For the latter, it can be implemented in the following manners, but is not limited to the follow: the above modules are all located in a same processor; or the above modules are located in different processors in any combination.

Still another aspect of the embodiments of the present disclosure further provides a server, which can be configured to execute the method for controlling communication based on a hardware partition system in the foregoing embodiments, and those that have already been described are not described herein again.

In this embodiment, the server, includes a host system, a Baseboard Management Controller (BMC), and a target communication bus between the host system and the BMC, wherein at least two operating systems are operated on a multi-core processor of the BMC, the host system is divided into a plurality of hardware partition systems, one of the at least two operating systems is configured to monitor an operating state of at least one of the plurality of hardware partition systems, a target communication interface of the BMC is configured for a first operating system in the at least two operating systems, and the target communication interface is a communication interface corresponding to the target communication bus.

The first operating system is configured to: acquire command data to be sent by a second operating system, wherein the second operating system is any one of the at least two operating systems other than the first operating system; recombine the command data to be sent, to obtain a target command message corresponding to the command data to be sent, wherein a target address in the target command message is a communication address of a target hardware partition system corresponding to the second operating system within the plurality of hardware partition systems; and send the target command message onto the target communication bus through the target communication interface of the first operating system; and

The target hardware partition system is configured to receive the target command message on the target communication bus through a target communication interface of the target hardware partition system.

In some exemplary embodiments, the at least two operating systems and the plurality of hardware partition systems can cooperate to execute steps in any one of the above method embodiments.

Still another aspect of the embodiments of the present disclosure further provides a BMC. The BMC can be configured to execute the method for controlling communication based on a hardware partition system in the foregoing embodiments, and those that have already been described are not described herein again.

In this embodiment, at least two operating systems are operated on a multi-core processor of the BMC, one of the at least two operating systems is configured to monitor an operating state of at least one of a plurality of hardware partition systems into which a host system is divided, the BMC communicates with the host system through a target communication bus, a target communication interface of the BMC is configured for a first operating system in the at least two operating systems, the target communication interface is a communication interface corresponding to the target communication bus, and the at least two operating systems further comprise a second operating system.

The first operating system is configured to: acquire command data to be sent by the second operating system, wherein the second operating system is any one of the at least two operating systems other than the first operating system; recombine the command data to be sent, to obtain a target command message corresponding to the command data to be sent, wherein a target address in the target command message is a communication address of a target hardware partition system corresponding to the second operating system within the plurality of hardware partition systems; and send the target command message onto the target communication bus through the target communication interface of the first operating system such that the target hardware partition system receives the target command message on the target communication bus through a target communication interface of the target hardware partition system.

In some exemplary embodiments, the at least two operating systems can cooperate to execute steps in any one of the above method embodiments.

Still another aspect of the embodiments of the present disclosure further provides a non-volatile readable storage medium. The non-volatile readable storage medium stores a computer program. Steps in any one of the above method embodiments are executed when the computer program is configured to run.

In an exemplary embodiment, the non-volatile readable storage medium can include, but is not limited to, a USB flash disk, a Read-Only Memory (ROM), a Random Access Memory (RAM), and various media that can store computer programs, such as a mobile hard disk, a magnetic disk, or an optical disk.

Still another aspect of the embodiments of the present disclosure further provides an electronic device. The electronic device includes a memory and a processor. The memory is configured to store a computer program. The processor is configured to run the computer program to execute steps in any one of method embodiments described above.

In an exemplary embodiment, the electronic device can further include a transmission device and an input/output device. The transmission device is connected to the processor. The input/output device is connected to the processor.

For optional examples in this embodiment, refer to the examples described in the foregoing embodiments and the exemplary implementations, and this embodiment will not be repeated thereto.

It is apparent that those skilled in the art should understand that the above mentioned modules or steps of the embodiments of the present disclosure can be implemented by a general computing device, and can also be gathered together on a single computing device or distributed in network composed of multiple computing devices. The above mentioned modules or steps of the present disclosure can be implemented with program codes executable by the computing device, so that can be stored in a storage device for execution by the computing device, and in some cases, the steps shown or described can be performed in a different sequence than herein, or can be fabricated into individual integrated circuit modules respectively, or multiple modules or steps thereof are fabricated into a single integrated circuit module for implementation. In this way, the embodiments of the present disclosure are not limited to any specific combination of hardware and software.

The above are only the optional embodiments of the present disclosure and are not intended to limit the embodiments of the present disclosure. For those skilled in the art, the embodiments of the present disclosure can have various modifications and variations. Any modifications, equivalent replacements, improvements and the like made within the principle of the embodiments of the present disclosure shall fall within the scope of protection of the embodiments of the present disclosure.

1. A method for controlling communication based on a hardware partition system, applied to a server comprising a Baseboard Management Controller (BMC) and a host system, wherein the BMC communicates with the host system through a target communication bus, at least two operating systems are operated on a multi-core processor of the BMC, the host system is divided into a plurality of hardware partition systems, one of the at least two operating systems is configured to monitor an operating state of at least one of the plurality of hardware partition systems, a target communication interface of the BMC is configured for a first operating system in the at least two operating systems, and the target communication interface is a communication interface corresponding to the target communication bus; and the method comprises:
acquiring command data to be sent by a second operating system through the first operating system, wherein the second operating system is any one of the at least two operating systems other than the first operating system;
recombining the command data to be sent through the first operating system, to obtain a target command message corresponding to the command data to be sent, wherein a target address in the target command message is a communication address of a target hardware partition system corresponding to the second operating system within the plurality of hardware partition systems; and
sending the target command message onto the target communication bus through the target communication interface of the first operating system such that the target hardware partition system receives the target command message on the target communication bus through a target communication interface of the target hardware partition system.

2. The method according to claim 1, wherein acquiring the command data to be sent by the second operating system through the first operating system comprises:
when it is determined that there is the command data to be sent by the second operating system, acquiring the command data to be sent from a first shared memory through the first operating system, wherein the first shared memory is configured to store command data to be sent by the other operating systems in the at least two operating systems other than the first operating system.

3. The method according to claim 2, wherein when it is determined that there is the command data to be sent by the second operating system, acquiring the command data to be sent from the first shared memory through the first operating system comprises:
when it is determined that there is the command data to be sent by the second operating system, acquiring the command data to be sent from a first data structure of the first shared memory according to a system identifier of the second operating system through the first operating system, wherein the first data structure is configured to store command data to be sent by the other operating systems by using at least one command parameter according to system identifiers of the other operating systems, and the command data to be sent by the other operating systems comprises parameter information of the at least one command parameter corresponding to the other operating systems.

4. The method according to claim 3, wherein the other operating systems comprise a plurality of other operating systems, system identifiers of the at least two operating systems are continuously arranged, the first data structure is configured to sequentially store the command data to be sent by each other operating system in the plurality of other operating systems according to a sequence of the system identifiers of the plurality of other operating systems; and
when it is determined that there is the command data to be sent by the second operating system, acquiring the command data to be sent from the first data structure of the first shared memory according to the system identifier of the second operating system through the first operating system comprises:
when it is determined that there is the command data to be sent by the second operating system, acquiring the command data to be sent from a storage position corresponding to the system identifier of the second operating system in the first data structure through the first operating system.

5. The method according to claim 4, wherein the at least one command parameter comprises at least one of the following: a write length, a read length, a command code, a write parameter; in the first data structure, the parameter information of the at least one command parameter corresponding to the same other operating system is sequentially continuously stored; or in the first data structure, the parameter information of the same command parameter in the at least one command parameter corresponding to the plurality of other operating systems is sequentially continuously stored.

6. The method according to claim 1, wherein acquiring the command data to be sent by the second operating system through the first operating system comprises:
receiving a first inter-core communication request sent by the second operating system through the first operating system, wherein the first inter-core communication request carries the command data to be sent.

7. The method according to claim 1, wherein in the at least two operating systems, there are a plurality of other operating systems other than the first operating system; and before acquiring the command data to be sent by the second operating system through the first operating system, the method further comprises:
sequentially detecting a ready-to-send flag bit corresponding to each other operating system of the plurality of other operating systems in a second data structure of a second shared memory through the first operating system, wherein the ready-to-send flag bit is configured to identify whether there is command data to be sent by a corresponding other operating system; and
when it is detected that the ready-to-send flag bit corresponding to the second operating system is a first value, determining that there is command data to be sent by the second operating system, wherein the first value is configured to indicate that there is command data to be sent by a corresponding other operating system.

8. The method according to claim 7, wherein after acquiring the command data to be sent by the second operating system through the first operating system, the method further comprises:
setting the ready-to-send flag bit corresponding to the second operating system to a second value through the first operating system, wherein the second value is configured to indicate that there is no command data to be sent by a corresponding other operating system.

9. The method according to claim 1, wherein recombining the command data to be sent through the first operating system, to obtain the target command message corresponding to the command data to be sent comprises:
determining a command type corresponding to the command data to be sent to obtain a target command type, wherein the target command type is a command type of a preset command used to send the command data to be sent; and
recombining the command data to be sent according to a command format corresponding to the target command type, to obtain the target command message corresponding to the command data to be sent.

10. The method according to claim 1, wherein in the at least two operating systems, there are a plurality of other operating systems other than the first operating system, and a difference value between a communication address of a hardware partition system corresponding to each of the plurality of other operating systems and a communication address of a hardware partition system corresponding to the first operating system has a specified correspondence relationship with a difference value between a system identifier of each of the plurality of other operating systems and a system identifier of the first operating system; and
before recombining the command data to be sent through the first operating system, the method further comprises:
determining a communication address of the target hardware partition system corresponding to the second operating system through the first operating system according to the specified correspondence relationship, a difference value between a system identifier of the first operating system and a system identifier of the second operating system, and a communication address of a hardware partition system corresponding to the first operating system.

11. The method according to claim 1, wherein after sending the target command message onto the target communication bus through the target communication interface of the first operating system, the method further comprises:
receiving a target response message on the target communication bus through the first operating system, wherein the target response message is response data returned by the target hardware partition system in response to the target command message, and the target response message carries a communication address of the target hardware partition system; and
determining that the target response message is a response message to be sent to the second operating system according to the communication address of the target hardware partition system through the first operating system, and sending the target response message to the second operating system through the first operating system.

12. The method according to claim 11, wherein sending the target response message to the second operating system through the first operating system comprises:
writing target response data in the target response message to a third shared memory through the first operating system such that the second operating system reads the target response data from the third shared memory, wherein the third shared memory is configured to store response data that is sent to other operating systems in the at least two operating systems other than the first operating system.

13. The method according to claim 12, wherein writing target response data in the target response message to the third shared memory through the first operating system comprises:
writing the target response data to a third data structure of the third shared memory according to a system identifier of the second operating system through the first operating system, wherein the third data structure is configured to store the response data to be sent to the other operating systems by using at least one specified parameter according to system identifiers of the other operating systems, and the response data sent to the other operating systems comprises parameter information of the at least one specified parameter corresponding to the other operating systems.

14. The method according to claim 13, wherein the other operating systems comprise a plurality of other operating systems, system identifiers of the at least two operating systems are continuously arranged, the third data structure is configured to sequentially store the response data to be sent to each other operating system in the plurality of other operating systems according to a sequence of system identifiers of the plurality of other operating systems; and
writing the target response data to the third data structure of the third shared memory according to the system identifier of the second operating system through the first operating system comprises:
writing the target response data to a storage position corresponding to the system identifier of the second operating system in the third data structure through the first operating system.

15. The method according to claim 14, wherein the at least one specified parameter comprises at least one of the following: a verification sequence generated by a hardware partition system sending the response data, valid data in the response data, a verification sequence received by the hardware partition system sending the response data; in the third data structure, the parameter information of the at least one specified parameter corresponding to the same other operating system is sequentially continuously stored; or in the third data structure, the parameter information of the same specified parameter in the at least one specified parameter corresponding to the plurality of other operating systems is sequentially continuously stored.

16. The method according to claim 12, wherein in the at least two operating systems, there are a plurality of other operating systems; and after writing target response data in the target response message to the third shared memory through the first operating system, the method further comprises:
setting a ready-to-receive flag bit corresponding to the second operating system in a fourth data structure of a fourth shared memory to a third value through the first operating system, wherein the ready-to-receive flag bit is configured to identify whether there is response data that is sent to a corresponding operating system, and the third value is configured to indicate that there is response data that is sent to a corresponding operating system;
detecting the ready-to-receive flag bit corresponding to the second operating system in the fourth data structure through the second operating system; and
when detecting that the ready-to-receive flag bit corresponding to the second operating system is the third value, reading the target response data from the third shared memory through the second operating system.

17. (canceled)

18. The method according to claim 11, wherein sending the target response message to the second operating system through the first operating system comprises:
sending a second inter-core communication request to the second operating system through the first operating system, wherein the second inter-core communication request carries target response data in the target response message.

19. The method according to any of claim 1, wherein the target communication bus is a Platform Environment Control Interface (PECI) bus, and the target communication interface is a PECI; and a communication between one operating system of the at least two operating systems and a hardware partition system corresponding to the one operating system is initiated by the one operating system as a host device to the hardware partition system corresponding to the one operating system as a client device, and the PECI of the BMC is allocated to the first operating system through only allowing the first operating system to access a PECI controller of the BMC.

20. (canceled)

21. A server, comprising a host system, a Baseboard Management Controller (BMC), and a target communication bus between the host system and the BMC, wherein at least two operating systems are operated on a multi-core processor of the BMC, the host system is divided into a plurality of hardware partition systems, one of the at least two operating systems is configured to monitor an operating state of at least one of the plurality of hardware partition systems, a target communication interface of the BMC is configured for a first operating system in the at least two operating systems, and the target communication interface is a communication interface corresponding to the target communication bus;
the first operating system is configured to: acquire command data to be sent by a second operating system, wherein the second operating system is any one of the at least two operating systems other than the first operating system; recombine the command data to be sent, to obtain a target command message corresponding to the command data to be sent, wherein a target address in the target command message is a communication address of a target hardware partition system corresponding to the second operating system within the plurality of hardware partition systems; and send the target command message onto the target communication bus through the target communication interface of the first operating system; and
the target hardware partition system is configured to receive the target command message on the target communication bus through a target communication interface of the target hardware partition system.

22. A Baseboard Management Controller (BMC), wherein at least two operating systems are operated on a multi-core processor of the BMC, one of the at least two operating systems is configured to monitor an operating state of at least one of a plurality of hardware partition systems into which a host system is divided, the BMC communicates with the host system through a target communication bus, a target communication interface of the BMC is configured for a first operating system in the at least two operating systems, the target communication interface is a communication interface corresponding to the target communication bus, and the at least two operating systems further comprise a second operating system;
the first operating system is configured to: acquire command data to be sent by the second operating system, wherein the second operating system is any one of the at least two operating systems other than the first operating system; recombine the command data to be sent, to obtain a target command message corresponding to the command data to be sent, wherein a target address in the target command message is a communication address of a target hardware partition system corresponding to the second operating system within the plurality of hardware partition systems; and send the target command message onto the target communication bus through the target communication interface of the first operating system such that the target hardware partition system receives the target command message on the target communication bus through a target communication interface of the target hardware partition system.

23-24. (canceled)
